(19) United States
(12) Patent Application Publication
(10) Pub. No.: US 2022/0179366 A1
(43) Pub. Date: Jun. 9, 2022

(54) Reduced Power Electrical Illumination For A Timepiece

(71) Applicant: PAR WEBER LLC, Chicago, IL (US)

(72) Inventor: Jonathan Weber, Chicago, IL (US)

(21) Appl. No.: 17/440,497

(22) PCT Filed: Mar. 18, 2020
(86) PCT No.: PCT/US2020/023390

§ 371 Date: Sep. 17, 2021

Related U.S. Application Data
(60) Provisional application No. 62/820,055, filed on Mar. 18, 2019.

(51) Int. Cl. G04B 19/30; F21V 3/06; F21V 23/02; F21V 23/04; G04G 9/00; G04G 17/04; G04G 19/12

(52) U.S. Cl. CPC G04B 19/30; F21V 3/0625; F21V 23/02; F21Y 2115/10; G04G 9/0017; G04G 17/045; G04G 19/12; F21V 23/0464

(57) ABSTRACT

A method for providing illumination to a timepiece includes providing an array of LEDs arranged around a periphery of a substantially planar surface such that each LED in the array of LEDs emits light toward a center of the periphery. The substantially planar surface overlays a timepiece movement having a watch hand pinion that extends through a hole in the substantially planar surface. The substantially planar surface is bounded by a casing of the timepiece. The method also includes situating each of the LEDs in a diffuser layer extending across the substantially planar surface to scatter light emitted by each LED. The method also includes applying power to the array of LEDs such that each LED is driven at a current lower than a specified current for normal operation of the LED.

### RELATED APPLICATIONS

This application claims priority to U.S. Provisional Patent Application No. 62/820,055, entitled “REDUCED-POWER ELECTRICAL ILLUMINATION FOR A WRISTWATCH OR SIMILAR INSTRUMENT,” filed Mar. 18, 2019, the contents of which are expressly incorporated herein.

### BACKGROUND

Wristwatches and other timepieces are worn by users as a mechanism to tell time. However, if the ambient conditions are dark, a user may not be able to see the watch dials on a wristwatch. For example, if a user walks into a dark room and looks at his or her wristwatch to determine the time, the user may not be able to adequately view the watch dials of the wristwatch to determine the time.

In some scenarios, manufacturers apply phosphorescent paints and adhesives to the watch dials and hands of a wristwatch to illuminate a face of the wristwatch. However, phosphorescent paints need to be charged by a light source to adequately illuminate, phosphorescent paints lose their luminescence relatively fast, and phosphorescent paints are subject to impaired performance over time. In other scenarios, manufacturers use radio-luminescent tritium gas tubes to illuminate the face of the wristwatch. However, radio-luminescent tritium gas tubes emit beta radiation and lose their luminescence over time. For example, radio-luminescent tritium gas tubes lose their luminescence according to the half-life of tritium (e.g., approximately twelve years).

In other scenarios, manufacturers use electroluminescent backlight panels to illuminate the face of the wristwatch. However, electroluminescent backlight panels typically draw a significant amount of power. As such, electroluminescent backlight panels can have a relatively short activation cycle to preserve battery power. In other scenarios, manufacturers use lamp-style illuminators to project light across the face of the wristwatch. However, similar to electroluminescent backlight panels, lamp-style illuminators draw a significant amount of power, and thus have a relatively short activation cycle to preserve battery power.

### SUMMARY

In one example, a timepiece includes an array of light emitting diodes (LEDs) on a substantially planar surface. The timepiece also includes a diffuser overlying the array of LEDs. The diffuser spans substantially an entirety of the substantially planar surface to assist in scattering the light emitted by each of the LEDs such that the scattered light illuminates substantially an entirety of the diffuser. The timepiece further includes a dial overlying the diffuser, wherein the dial is substantially transparent to allow for scattered light in the diffuser to be visible through the dial.

In a further example, a timepiece includes a printed circuit board and a plurality of light emitting diodes (LEDs) mounted to the printed circuit board. The timepiece also includes a power regulating circuit configured to limit an average power supplied from a power source to the plurality of LEDs to three-hundred microwatts or less to enable substantially continuous illumination of the plurality of LEDs. The timepiece further includes a diffuser positioned adjacent to the printed circuit board to scatter light from the plurality of LEDS to illuminate a watch dial bonded to the diffuser.

In a further example, a method of manufacturing a timepiece includes mounting a plurality of LEDs to a printed circuit board. The method also includes encapsulating the plurality of LEDs into a diffuser. The method further includes bonding the watch dial on to the diffuser such that the diffuser substantially uniformly scatters light from the plurality of LEDs to illuminate a watch dial. The method also includes coupling a power supply to the plurality of LEDs and the power regulating circuit such that the power regulating circuit limits an average power supplied from a power source to the plurality of LEDs to three-hundred microwatts or less to enable substantially continuous illumination of the plurality of LEDs.

In a further aspect, a method for providing illumination to a timepiece includes providing an array of LEDs arranged around a periphery of a substantially planar surface such that each LED in the array of LEDs emits light toward a center of the periphery. The substantially planar surface overlays a timepiece movement having a watch hand pinion that extends through a hole in the substantially planar surface. The substantially planar surface is bounded by a casing of the timepiece. The method also includes situating each of the LEDs in a diffuser layer extending across the substantially planar surface to scatter light emitted by each LED. The method also includes applying power to the array of LEDs such that each LED is driven at a current lower than a specified current for normal operation of the LED.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a diagram of components of a timepiece that electrically illuminates using a substantially low amount of power, according to an example embodiment.

FIG. 2 is a simplified diagram of a watch dial, a diffuser, and a printed circuit board, according to an example embodiment.

FIG. 3A is a diagram of a printed circuit board having light emitting diodes mounted in an inner ring and in an outer ring, according to an example embodiment.

FIG. 3B is a diagram of a circuit board having mounted light emitting diodes, according to an example embodiment.

FIG. 3C is a diagram of a first side of a circuit board, according to an example embodiment.

FIG. 3D is a diagram of a second side of a circuit board, according to an example embodiment.

FIG. 3E is a diagram of a diffuser, according to an example embodiment.

FIG. 3F is a diagram of diffuser overlaid on a circuit board, according to an example embodiment.

FIG. 4 is a circuit diagram of a circuit board having a plurality of light emitting diodes coupled in parallel, according to an example embodiment.

FIG. 5 is a flowchart of a method of manufacturing a timepiece, according to an example embodiment.

FIG. 6 is a diagram of components of a timepiece, according to an example embodiment.

FIG. 7 is a flowchart of a method of illuminating a timepiece, according to an example embodiment.

### DETAILED DESCRIPTION

Example methods and systems are described herein. Other example embodiments or features may further be utilized, and other changes may be made, without departing from the scope of the subject matter presented herein. In the following detailed description, reference is made to the accompanying figures, which form a part thereof.

The ordinal terms first, second, and the like in the description and in the claims are used for distinguishing between similar elements and not necessarily for describing a sequence, either temporally, spatially, in ranking, or in any other manner. As such, it is to be understood that the ordinal terms can be interchangeable under appropriate circumstances.

The example embodiments described herein are not meant to be limiting. Thus, aspects of the present disclosure, as generally described herein and illustrated in the figures, can be arranged, substituted, combined, separated, and designed in a wide variety of different configurations, all of which are explicitly contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. OVERVIEW

Illustrative embodiments relate to a timepiece utilizing low power electrical illumination. To illustrate, a light emitting diode (LED) array is incorporated into a timepiece and driven at a low power. For example, the LED array is driven by less than three-hundred (300) microwatts. As a result of driving the LED array at low power, the LED array can continuously illuminate for an extended period of time. For example, when selecting Indium Gallium Nitride (InGaN) LEDs that have a forward voltage between 2.5 volts and 3.5 volts, the LEDs can continuously illuminate for over a year using a current of less than one microampere. A power regulating circuit is used to regulate (e.g., control) the amount of current that is provided to each LED of the LED array and is used to regulate the voltage drop across each LED. Additionally, based on the low power application of the power source, the LEDs can be coupled in parallel without the risk of power hogging which could result in a cascading burnout.

### II. EXAMPLE SYSTEMS AND METHODS

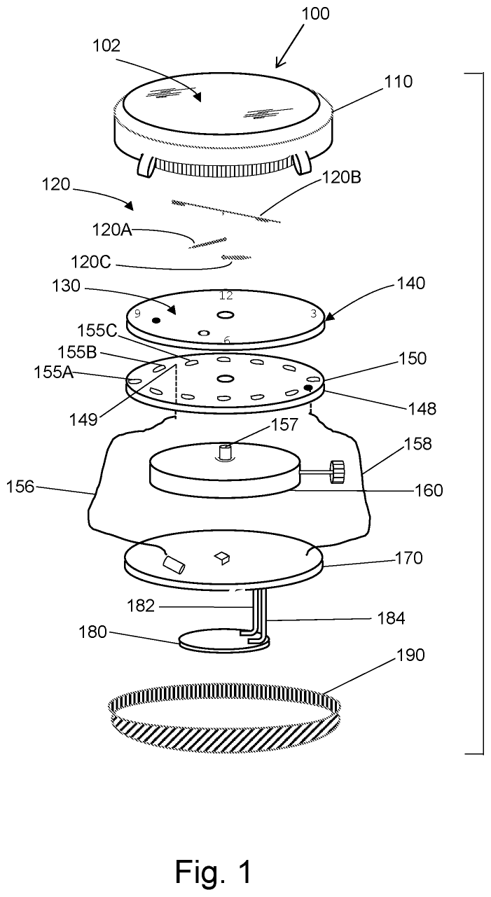

FIG. 1 is a diagram of components of a timepiece 100 that electrically illuminates using a substantially low amount of power. The timepiece 100 includes an upper casing 110, one or more clock hands 120, a watch dial 130, a diffuser 140, a printed circuit board (PCB) 150, a watch movement apparatus 160, a power regulating circuit 170, a power source 180, and a lower casing 190. It should be understood that the components illustrated in FIG. 1 are merely for illustrative purposes and, in some embodiments, additional (or fewer) components can be included in the timepiece 100. Once assembled, the timepiece 100 can be worn by a user and, in low light ambient environments, can continuously illuminate using a low amount of power. As non-limiting examples, the user can wear the assembled timepiece 100 around the user's wrist as a wristwatch, the user can wear the assembled timepiece 100 on a chain around the user's neck, etc.

The upper casing 110 is designed to protect interior components of the timepiece 100 against outside elements. In FIG. 1, the upper casing 110 includes a transparent portion 102, also known as a crystal. In some implementations, the transparent portion 102 is comprised of glass. In other implementations, the transparent portion 102 is comprised of plastic. As used herein, the upper casing 110 is located at the side of the timepiece 100 that is intended to face away from an arm of the user when the timepiece 100 is a wristwatch. For example, the user can look through the transparent portion 102 of the upper casing 110 to determine the time.

The clock hands 120 can be used to indicate a current time. For example, the clock hands 120 can include an hour hand 120A, a minute hand 120B, a second hand 120C, or a combination thereof. The clock hands 120 are arranged adjacent to the watch dial 130, such as by being secured to portions of a pinion 157 extending through a hole in the watch dial 130 to one or more wheels in the watch movement apparatus 160. The ends of the clock hands 120 are configured to rotate in a circle around the perimeter of watch dial 130 to indicate the time to the user. For example, the hour hand 120A is configured to make a complete rotation around the watch dial 130 every twelve hours, the minute hand 120B is configured to make a complete rotation around the watch dial 130 every hour, and the second hand 120C is configured to make a complete rotation around the watch dial 130 every minute.

In FIG. 1, the watch dial 130 is a transparent material that is bonded to the top of the diffuser 140. The watch dial 130 can include a face plate and a plurality of hour-mark apertures and/or numerical indicators on and/or extending through the face plate. For example, the watch dial 130 can include twelve (12) hour marks that extend through the face plate.

According to one implementation, the diffuser 140 can be a semi-transparent thermoplastic that is bonded to the watch dial 130. Although described as a thermoplastic, in some implementations, the diffuser 140 can be comprised of glass, acrylic, or other suitable materials. According to one implementation, the diffuser 140 can be a hot melt adhesive (for example, a polyamide) that can be used in a low-pressure molding application.

In the embodiment illustrated in FIG. 1, the diffuser 140 is bonded beneath the watch dial 130. In other embodiments, the watch dial 130 is incorporated into the diffuser 140. The diffuser 140 is configured to uniformly scatter light across the watch dial 130. However, in some implementations, the timepiece 100 can bypass use of the diffuser 140. For example, the timepiece 100 can utilize solutions (i.e., acrylic or fiber optics) leveraging complete internal reflection to transmit and redirect light from light emitting diodes (LEDs).

The PCB 150 is similar in size and shape to the watch dial 130 and the diffuser 140. The PCB 150 is configured to illuminate the watch dial 130 using LEDs 155. For example, the PCB 150 includes an array of LEDs 155 that provide light to the watch dial 130 by way of the diffuser 140. In the illustrative example of FIG. 1, there are twelve (12) LEDs 155 coupled to the PCB 150 to provide light to the watch dial 130. For example, a single LED 155 can be coupled proximate to each hour mark on the watch dial 130. To illustrate, an LED 155A is coupled to the PCB 150 proximate to the nine-hour mark on the watch dial 130, an LED 155B is coupled to the PCB 150 proximate to the ten-hour mark on the watch dial 130, an LED 155C is coupled to the PCB 150 proximate to the eleven-hour mark on the watch dial 130, etc.

Thus, as illustrated in FIG. 1, an array of LEDs 155 is disposed around a perimeter of a circuit board (e.g., the PCB 150). Each LED 155A-C in the array of LEDs 155 is arranged to emit lighter toward a center of the circuit board. As shown in FIG. 1, the diffuser 140 overlays the array of LEDs 155 and spans substantially an entirety of the circuit board (e.g., the PCB 150) to assist in scattering the light emitted by each of the LEDs 155A-C such that the scattered light illuminates substantially an entirety of the diffuser 140. Additionally, as described above, a dial (e.g., the watch dial 130) overlays the diffuser 140 and is substantially transparent to allow for the scattered light in the diffuser 140 to be visible through the dial.

In other implementations, fewer or additional LEDs 155 can be coupled to the PCB 150 to illuminate the watch dial 130. As a non-limiting example, an LED 155 can be coupled to the PCB 150 proximate to every third hour mark on the watch dial 130. To illustrate, an LED 155 can be coupled to the PCB 150 proximate to the three-hour mark on the watch dial 130, proximate to the six-hour mark on the watch dial 130, proximate to the nine-hour mark on the watch dial 130, and proximate to the twelve-hour mark on the watch dial 130.

In one embodiment, the LEDs 155 are Indium Gallium Nitride (InGaN) LEDs that have a forward voltage between 2.5 volts and 3.5 volts. In another embodiment, the LEDs 155 are InGaN LEDs that have a forward voltage between 3.0 volts and 3.3 volts. Thus, the forward voltage of the LEDs 155 is higher than that of red LEDs or amber LEDs, which typically have a forward voltage between 1.5 volts and 2.0 volts. The LEDs 155 are configured to generate light in response to receiving a trace amount of electrical power. For example, in response to receiving less than one microampere of current, each of the InGaN LEDs 155 are configured to generate light. To illustrate, the InGaN LEDs 155 can receive approximately one-half microampere of current, which is less than typically specified for normal operation, and generate light based on the current. In ambient conditions, the amount of light generated by the LEDs 155, in response to receiving the trace amount of electrical current, is not generally not visible to the human eye. However, in dark ambient conditions, the light generated by the LEDs 155, in response to receiving the trace amount of electrical current, is satisfactory to illuminate the watch dial 130. As a result of operating in response to receiving trace amounts of current, the LEDs 155 are uniquely configured to support continuous operation over an extended period of time. For example, selection of the InGaN LEDs 155 can support continuous operation over years.

Timepieces and other instruments can utilize power sources (e.g. batteries) having different nominal voltages. While many common watch batteries have a nominal voltage of 3.0V, others have nominal voltages of 1.35V, 1.4V, 1.45V, 1.5V, 1.55V, 2.8V, 3.6V, or 3.7V. Thus, some of the discussion herein is better understood in the context of average power that is supplied to the plurality or array of LEDs. The following examples set forth different tradeoffs that may be made with different average power applied to the plurality of LEDs.

According to a first example, the plurality of LEDs can be selected (e.g. choice of material, such as InGaN and quality-control) such that no more than 300 microwatts average power is supplied to the plurality of LEDs, while still emitting light. Assuming a 3V CR 2032 battery, with a capacity of 230 mAh, such a system could run continuously for approximately 75-100 days.

According to a second example, the plurality of LEDs can be selected (e.g. choice of material, such as InGaN and quality-control) such that no more than 100 microwatts average power is supplied to the plurality of LEDs, while still emitting light. Assuming a 3V CR 2032 battery, with a capacity of 230 mAh, such a system could run continuously for approximately 225-300 days.

According to a third example, the plurality of LEDs can be selected (e.g. choice of material, such as InGaN and quality-control) such that no more than 20 microwatts average power is supplied to the plurality of LEDs, while still emitting light. Assuming a 3V CR 2032 battery, with a capacity of 230 mAh, such a system could run continuously for approximately 1125-1500 days.

For the examples provided above, while results for a 3V CR 2032 battery were provided, batteries having different nominal voltages and ampere-hour ratings would allow for different continuous run times.

In one embodiment, the LEDs 155 are side-firing LEDs that direct light across the face of the timepiece 100 (e.g., across the watch dial 130). For example, the LEDs 155 can direct light from the perimeter or periphery of the timepiece 100 towards the center of the watch dial 130. In one embodiment, at least a portion of each of the LEDs 155 can be encapsulated in the diffuser 140 to minimize loss (i.e., Fresnel loss) between the lenses of the LEDs 155 and the diffuser 140. As a result, a relatively large amount of light generated by the LEDs 155 is captured by internal reflection prior to scattering and reflection towards the user.

The power regulating circuit 170 is electrically connected to LEDs 155, via the PCB 150, and to the power source 180. To illustrate, an electrical connection mechanism 156 (i.e., wire) is coupled to a pin 149 of the PCB 150 and is coupled to the power regulating circuit 170, and another electrical connection mechanism 158 is coupled to a pin 148 of the PCB 150 and is coupled to the power regulating circuit 170. Power from the power source 180 can be provided to the LEDs 155 through the power regulating circuit 170, the electrical connection mechanisms 156, 158, and the pins 148, 149. The power regulating circuit 170 is operable to illuminate the LEDs 155 at a low power. For example, the power regulating circuit 170 receives power from the power source 180 and regulates the amount of power (e.g., the amount of current and voltage) that is provided to the PCB 150 and the LEDs 155. Because the LEDs 155 can have particular high power ratings (i.e., power ratings far higher than would be feasible for continuous power under a coin cell battery), the power regulating circuit 170 controls or regulates the current consumption by the LEDs 155 such that the LEDs 155 can continuously operate at low power for up to years at a time. As a non-limiting example, the power regulating circuit 170 can regulate the current provided to the LEDs 155 to a current that is roughly one thousand times lower than the manufacturer specification for the LEDs 155. Thus, the power regulating circuit 170 is selected to be calibrated to work with settings for the specific LEDs 155.

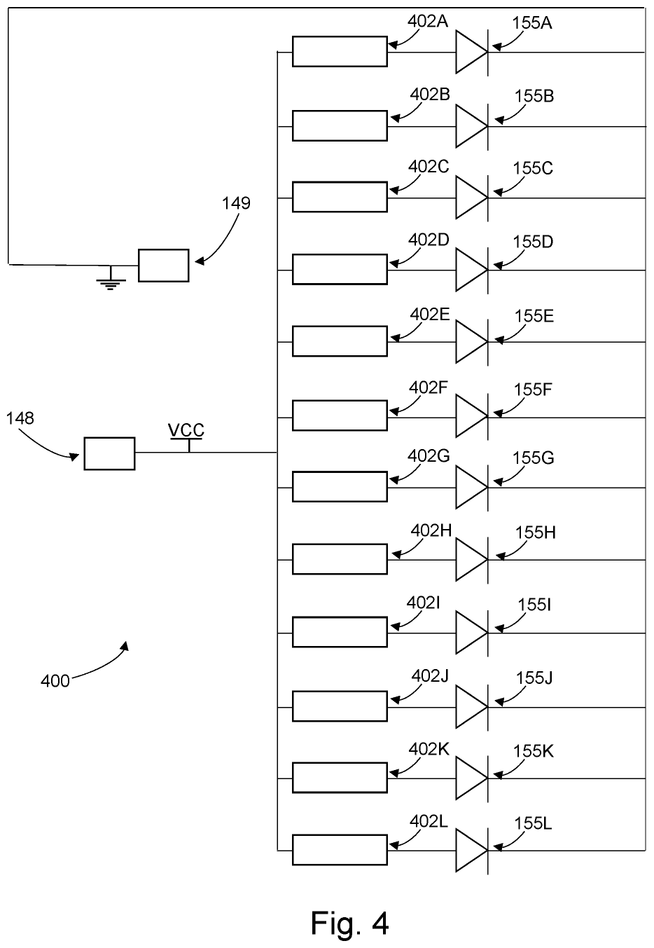

In some implementations, the power regulating circuit 170 can be a set of resistors each coupled in series with a respective LED 155, and with the series-connected resistor-LED combinations coupled in parallel with the power source 180. For example, the power regulating circuit 170 (e.g., the resistors) can be used to reduce the amount of voltage drop across the LEDs 155. Thus, the power regulating circuit 170 can be configured to offset the voltage drop across the LEDs 155. In other implementations, the power regulating circuit 170 can include a microcontroller, oscillators, and inductors that rapidly pulse the LEDs 155 with higher current. For example, the power regulating circuit 170 can perform pulse width modulation (PWM) to power the LEDs 155 at a higher current while maintaining a lower average power consumption. In a preferred embodiment, and as illustrated in FIG. 4, at least a portion, such as the series-connected resistors and associated traces, of the power regulating circuit 170, is provided only PCB 150, rather than on a separate dedicated board as illustrated in FIG. 1.

The power source 180 can include a battery with a Lithium Ion chemistry (e.g., a lithium ion battery) that has a nominal voltage of 3 volts. Other nominal voltages may alternatively be used. Based on the nominal voltage and above-described selection of LEDs, the power source 180 can power the LEDs 155 without the use of a boost converter, which would reduce battery efficiency and reduce battery lifespan. In one implementation, the power source 180 can include a coin cell battery that is dedicated to illumination of the LEDs 155. For example, the power from the power source 180 can be regulated by the power regulating circuit 170 and provided solely to the LEDs 155 to illuminate the watch dial 130. In other implementations, the power source 180 can be shared with a quartz movement circuit or a digital watch circuit. For example, in this implementation, power from the power source 180 can be utilized to power the clock hands 120.

The lower casing 190 is designed to protect interior components of the timepiece 100 against outside elements. As used herein, the lower casing 190 is located at the side of the timepiece 100 that is intended to face the arm of the user when the timepiece 100 is a wristwatch.

Thus, the timepiece 100 of FIG. 1 can be continuously illuminated for extended periods of time (i.e., over one year) based on the selection of the InGaN LEDs 155 and based on power regulation by the power regulating circuit 170. For example, by regulating the current provided to the LEDs 155 to a current that is roughly one thousand times lower than the manufacturer specification, the LEDs 155 can continuously emit light for an extended amount of time.

It should be appreciated that in some implementations, with the addition of an auto-off function operating in conjunction with a light detection circuit (not shown), the lifespan of the LEDs 155 can be further extended and power consumption of the timepiece 100 can be reduced. For example, photodetectors (not shown) can be integrated into the watch dial 130, the PCB 150, the LEDs 155, or other components of the timepiece 100. The photodetectors can detect when ambient light satisfies a threshold. For example, the photodetectors can detect when the ambient light is sufficient to permit the user to read the clock hands 120 without light from the LEDs 155. In response to detecting ambient light that satisfies the threshold, a microcontroller (not shown) integrated into the power regulating circuit 170 can disconnect the LEDs 155 from the power source 180 to extend the lifespan of the LEDs 155 and reduce power consumption of the timepiece 100.

It should further be appreciated that in some implementations, with the addition of an auto-off function operating in conjunction with one or more movement sensors (not shown), the lifespan of the LEDs 155 can be further extended and power consumption of the timepiece 100 can be reduced. For example, a low power accelerometer can detect when the timepiece 100 is stationary for a time period that exceeds a threshold. In response to detecting that the timepiece 100 is stationary for an extended period of time, a microcontroller (not shown) integrated into the power regulating circuit 170 can disconnect the LEDs 155 from the power source 180 to extend the lifespan of the LEDs 155 and reduce power consumption of the timepiece 100. Thus, the microcontroller can deactivate the LEDs 155 when the user is asleep, when the user places the timepiece 100 in storage, etc.

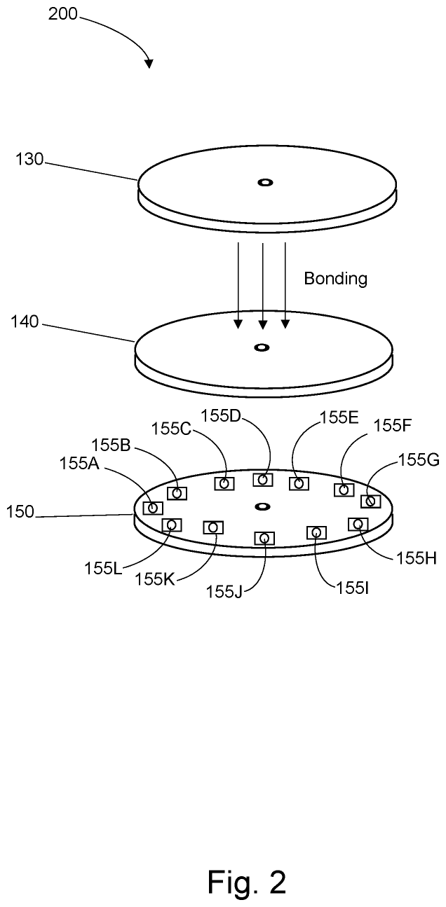

FIG. 2 is a simplified diagram 200 of the watch dial 130, the diffuser 140, and the PCB 150, according to an example embodiment.

In the illustrated embodiment of FIG. 2, the watch dial 130 is bonded to the diffuser 140. For example, the watch dial 130 can be a transparent material that is bonded to the top of the diffuser 140. However, in other implementations, the watch dial 130 and the diffuser 140 can have alternative configurations. For example, in one implementation, the watch dial 130 can be incorporated into the diffuser 140. In another implementation, the watch dial 130 can be underneath the diffuser 130 and on top of the LEDs 155.

In the example embodiment of FIG. 2, the PCB 150 includes twelve (12) LEDs 155A-L. For example, the LEDs 155A-L are mounted on the PCB 150. The LEDs 155A-L can be precisely mated to the diffuser 140 such that the light generated by the LEDs 155A-L is carried through the diffuser 140 to illuminate the watch dial 130. For example, the diffuser 140 is precisely paired (i.e., mechanically fitted and coupled) to the LED array (e.g., the LEDs 155A-L) to promote maximal transmission of light into the diffuser 140, which scatters the light and more uniformly illuminates the dial markings (on the watch dial 130) and the clock hands 120 from behind.

According to one implementation, the PCB 150 is made of white or reflective material so that light that is scattered by the diffuser 140 reflects off the PCB 150 and towards the user. According to one implementation, the PCB 150 can be shaped to promote light scattering and light reflection. For example, the PCB 150 can have a slight concave shape to promote light scattering and light reflection.

The configuration of the LEDs 155 in FIG. 2 can enable the use of diffuse light to broadly illuminate the watch dial 130. Additionally, the configuration of the LEDs 155 in this implementation can enable the use of the LEDs 155 as point sources of light to serve as indicators of the hour indices, to aid in orientation, etc.

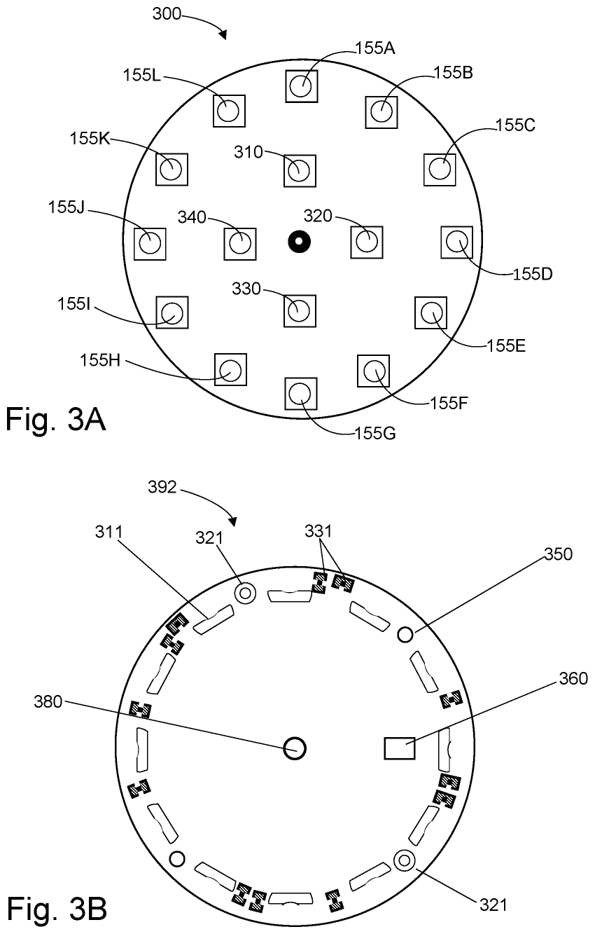

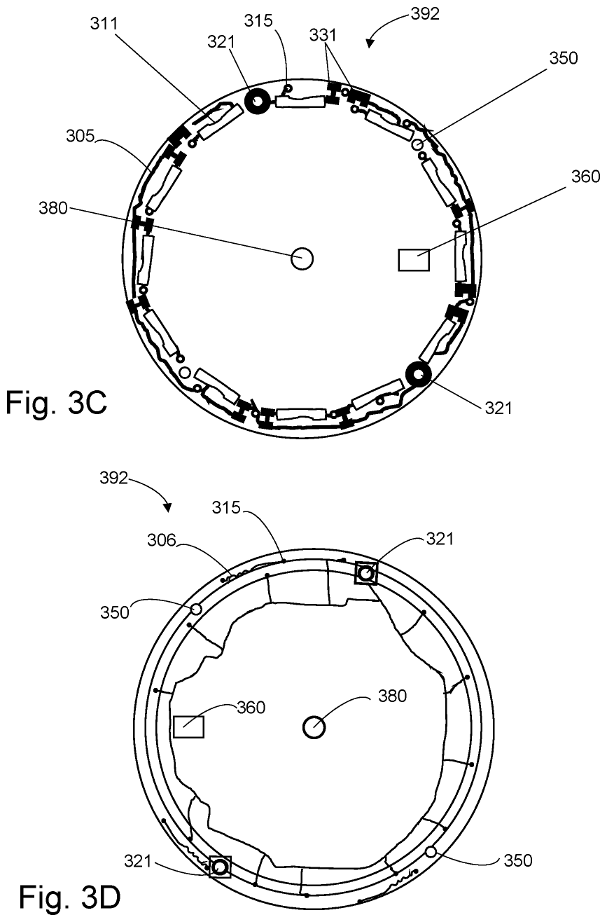

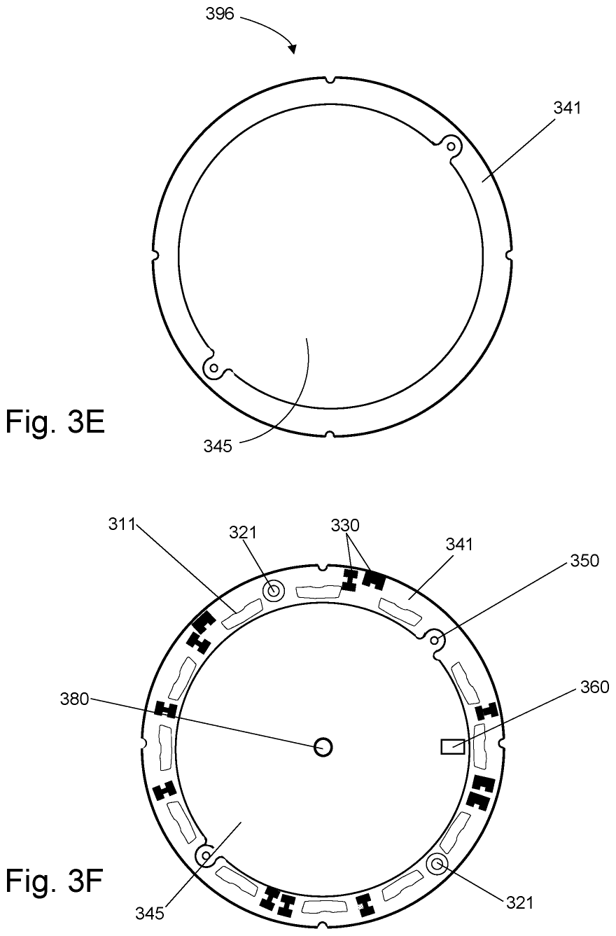

It should be appreciated that alternative configurations of LEDs can be used with the techniques described herein. For example, referring to FIG. 3A, an alternative configuration of LEDs on a PCB 300 is depicted. The PCB 300 of FIG. 3A can correspond to the PCB 150 of FIGS. 1-2. For example, the PCB 300 can be integrated into the timepiece 100 of FIG. 1. Similar to the PCB 150, the PCB 300 includes the LEDs 155A-L mounted proximate to the hour marks on the watch dial 130 as an “outer ring” of LEDs. However, the PCB 300 also includes additional LEDs 310-340 mounted as an “inner ring” of LEDs. For example, the inner ring of LEDs 310-340 can include an LED 310 mounted proximate to the twelve-hour mark one the watch dial 130, an LED 320 mounted proximate to the three-hour mark on the watch dial 130, an LED 330 mounted proximate to the six-hour mark on the watch dial 130, and an LED 340 mounted proximate to the nine-hour mark on the watch dial 130. According to one implementation, the inner ring of LEDs 310-340 can serve as an orientation aid (i.e. for a compass indicating North, South, East, and West directions). Thus, there can be numerous configurations of LEDs according to the techniques described herein.

FIG. 3B is a diagram of a circuit board 392 having mounted light emitting diodes. According to one implementation, the circuit board 392 can correspond to the PCB 150 of FIG. 1. For example, the circuit board 392 can be integrated into the timepiece 100. FIG. 3B depicts a top view of the circuit board 392, without conductive traces 305. For example, FIG. 3B depicts the side of the circuit board 392 that is proximate to the diffuser 140 and/or watch dial 130.

The circuit board 392 includes pins 321, which are similar to the pins 148 and 149 in FIG. 1. The circuit board 392 also depicts resistors 331. According to one implementation, the resistors are surface mount resistors, as described with respect to FIG. 4. Also shown are dial feet locations 350 that, in one embodiment, receive little extensions from the watch dial 130 that fit on the dial feet locations 350 to keep the watch dial 130 aligned to the circuit board 392. In one example, the circuit board 392 can be white, or comprised of a reflective material, and can include a viewport 360 for a user to see a date or other data. The circuit board 392 also includes an aperture 380 (i.e., a hole) through which a pinion 157 may extend to secure watch hands 120 to display time. The circuit board 392 also includes LEDs 311 (e.g., surface mount LEDs).

FIG. 3C is a diagram showing a top view of the circuit board 392 of FIG. 3B, with conductive traces included. According to one implementation, the circuit board 392 can correspond to the PCB 150 of FIG. 1. For example, the circuit board 392 can be integrated into the timepiece 100.

The circuit board 392 includes pins 321, the aperture 380 for a pinion 157, the viewport 360, the LEDs 311, the resistors 331, and conductive traces (or other conductors) 305. According to one embodiment, each LED 311 is in series with a resistor 331, and each LED-resistor combination is in parallel with each other LED-resistor combination. According to one embodiment, the conductive traces 305 pass through small openings (i.e. vias) 315 and continue on the opposite side (e.g., the side depicted in FIG. 3D).

FIG. 3D is a diagram of a second side (i.e. the bottom side) of the circuit board 392. FIG. 3C depicts a bottom view of the circuit board 392. For example, FIG. 3C depicts the side of the circuit board 392 that is proximate to the power regulating circuit 170 (and any additional watch components, such as the watch movement apparatus 160, for example. In FIG. 3D, the circuit board 392 includes pins 321, the aperture 380, and the viewport 360. As displayed in one embodiment, this side of 392 also includes conductive traces 306 which pass through small openings 315 to connect to traces and circuitry on the opposite side (i.e., the front side depicted in FIG. 3C). Additional circuitry beyond that illustrated in FIGS. 3C and 3D may be included on the circuit board 392.

FIG. 3E is a diagram of a diffuser 396. According to one implementation, the diffuser 396 can correspond to the diffuser 140 of FIG. 1. For example, the diffuser 396 can be integrated into the timepiece 100.

In FIG. 3E, the diffuser 396 has a shape to cover the LEDs on the perimeter of PCB 150. Additionally, the diffuser 396 includes cutouts to allow for dial feet alignment. The diffuser 396 may be transparent. In one embodiment, the diffuser 396 may be molded of uniform thickness onto a circuit board, such as the PCB 150. In another embodiment, the diffuser 396 may have a thicker outer portion 341 to cover on or over the LEDs portion of PCB 150 and a thinner inner portion 345. For a circular watch dial, for example, the outer portion 341 may be shaped as a thicker concentric outer circle portion, and the inner portion may be a thinner circle portion inside the outer portion 341. The diffuser 396 is preferably constructed of a single unitary piece.

FIG. 3F is a diagram of diffuser overlaid on a circuit board. In this embodiment, the diffuser 396 has cutouts around the dial feet locations 350. Conductive traces and vias have been omitted from this figure for improved clarity.

FIG. 4 is a circuit diagram 400 of a circuit board having a plurality of LEDs coupled in parallel with one another. The circuit diagram 400 includes a pin 148, a pin 149, and the plurality of LEDs 155A-L. The circuit diagram 400 can correspond to an electrical layout of the LEDs 155 on the PCB 150 of FIG. 1.

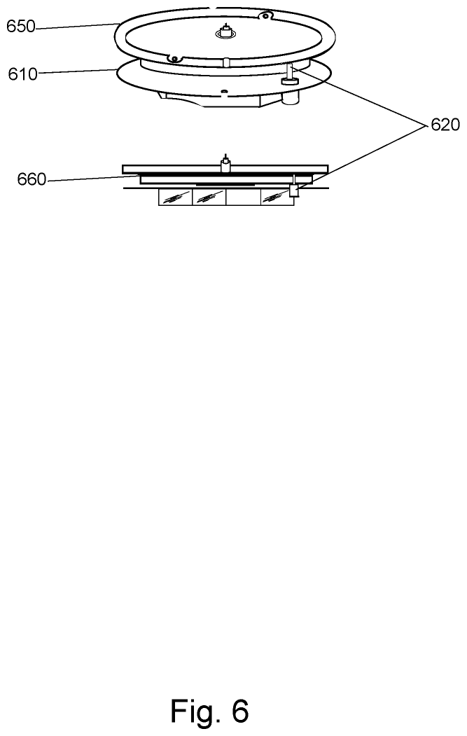

The power source 180A (or in another embodiment power source 610 as shown in FIG. 6) includes a supply voltage (VCC) at pin 148. The supply voltage (VCC) can have a nominal voltage of 3 volts relative to a ground at pin 149. Based on the nominal voltage, the power source 180A can power the LEDs 155 without the use of a boost converter, which would reduce battery efficiency and reduce battery lifespan. In one implementation, the power source 180A can include a battery with a Lithium Ion chemistry.

The power regulation circuitry 170A can include a plurality of resistors 402A-L each in series with a respective one of the plurality of LEDs 155A-L. The series-connected combinations of LEDs 155A-L and resistors 402A-L are coupled in parallel with one another. For example, the cathode terminal of each LED 155A-L is coupled to ground. The anode terminal of the LED 155A is coupled to a first terminal of the resistor 402A, and a second terminal of the resistor 402A is coupled to the supply voltage (VCC). In a similar manner, the anode terminal of each other LED 155B-L is coupled to a first terminal of the corresponding resistor 402B-L, and a second terminal of the corresponding resistor 402B-L is coupled to the supply voltage (VCC).

Typically LEDs are not coupled in parallel because of the likelihood of “power hogging” from variations in LED internal resistance which could result in a cascading burnout of the LEDs. However, based on the low power application of the power source 180A contemplated herein, the LEDs 155A-L can be coupled in parallel (as illustrated in FIG. 4) without the risk of power hogging which could in a cascading burnout.

In one embodiment, the LEDs 155A-L are InGaN LEDs that have a forward voltage between 2.5 volts and 3.5 volts. In another embodiment, the LEDs 155A-L are InGaN LEDs that have a forward voltage between 3.0 volts and 3.3 volts. Thus, the forward voltage of the LEDs 155A-L is higher than that of red LEDs or amber LEDs, which typically have a forward voltage between 1.5 volts and 2.0 volts. The LEDs 155A-L are configured to generate light in response to receiving a trace amount of electrical current. For example, in response to receiving less than one microampere of current, each of the InGaN LEDs 155A-L is configured to generate light. To illustrate, the InGaN LEDs 155A-L can receive approximately one-half microampere of current and generate light based on the current. In ambient conditions, the amount of light generated by the LEDs 155A-L, in response to receiving the trace amount of electrical current, is not generally not visible to the human eye. However, in dark ambient conditions, the light generated by the LEDs 155A-L, in response to receiving the trace amount of electrical current, is satisfactory to illuminate the watch dial 130. As a result of operating in response to receiving trace amounts of current, the LEDs 155A-L are uniquely configured to support continuous operation over an extended period of time. For example, selection of the InGaN LEDs 155A-L can support continuous operation over years.

Timepieces and other instruments can utilize power sources (e.g. batteries) having different nominal voltages. While many common watch batteries have a nominal voltage of 3.0V, others have nominal voltages of 1.35V, 1.4V, 1.45V, 1.5V, 1.55V, 2.8V, 3.6V, or 3.7V. Thus, some of the discussion herein is better understood in the context of average power that is supplied to the plurality or array of LEDs. The following examples set forth different tradeoffs that may be made with different average power applied to the plurality of LEDs.

According to a first example, the plurality of LEDs can be selected (e.g. choice of material, such as InGaN and quality-control) such that no more than 300 microwatts average power is supplied to the plurality of LEDs, while still emitting light. Assuming a 3V CR 2032 battery, with a capacity of 230 mAh, such a system could run continuously for approximately 75-100 days.

According to a second example, the plurality of LEDs can be selected (e.g. choice of material, such as InGaN and quality-control) such that no more than 100 microwatts average power is supplied to the plurality of LEDs, while still emitting light. Assuming a 3V CR 2032 battery, with a capacity of 230 mAh, such a system could run continuously for approximately 225-300 days.

According to a third example, the plurality of LEDs can be selected (e.g. choice of material, such as InGaN and quality-control) such that no more than 20 microwatts average power is supplied to the plurality of LEDs, while still emitting light. Assuming a 3V CR 2032 battery, with a capacity of 230 mAh, such a system could run continuously for approximately 1125-1500 days.

For the examples provided above, while results for a 3V CR 2032 battery were provided, batteries having different nominal voltages and ampere-hour ratings would allow for different continuous run times.

In one embodiment, the LEDs 155A-L are side-firing LEDs that direct light across the face of the timepiece 100 (e.g., across the watch dial 130). For example, the LEDs 155A-L can direct light from the perimeter of the timepiece 100 towards the center of the watch dial 130. In one embodiment, the LEDs 155A-L can be encapsulated in the diffuser 140 to minimize loss (i.e., Fresnel loss) between lenses of the LEDs 155A-L and the diffuser 140. As a result, a relatively large amount of light generated by the LEDs 155A-L is captured by internal reflection prior to scattering and reflection towards the user.

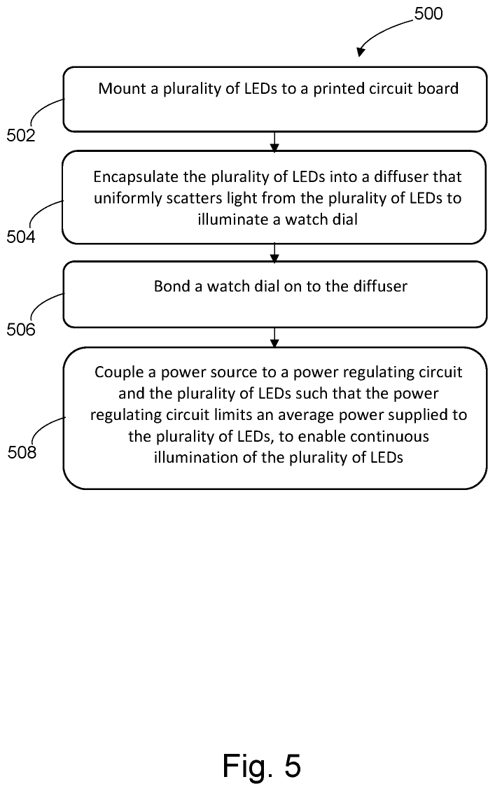

FIG. 5 is a flowchart of a method 500 of manufacturing a timepiece, according to a specific example. The method 500 can be performed by dedicated circuitry or by commands executed by a timepiece manufacturing machine. The method 500 can be performed to manufacture the timepiece 100 of FIG. 1.

The method includes mounting a plurality of LEDs to a printed circuit board, at 502. For example, the LEDs 155 can be mounted to the printed circuit board 150.

The method 500 also includes encapsulating the plurality of LEDs into a diffuser that uniformly scatters light from the plurality of LEDs to illuminate a watch dial, at 504. For example, the LEDs 155 can be encapsulated in the diffuser 140.

The method 500 further includes bonding a watch dial to the diffuser, at 506. For example, the watch dial 130 can be bonded to the diffuser 140.

The method 500, at 508, yet further includes coupling a power source to a power regulating circuit and the plurality of light emitting diodes (LEDs) such that the power regulating circuit limits an average power supplied, from the power source, to the plurality of LEDs, to enable continuous illumination of the plurality of LEDs. For example, for a power supply having a nominal voltage of 3 volts, the average power can be limited to three-hundred microwatts or less. For example, the power regulating circuit 170 can be coupled to the LEDs 155, at 502. For example, the power source 180 can be coupled to the LEDs 155 and power regulating circuit 170. The method 500 enables manufacturing of the timepiece 100 that can be continuously illuminated for extended periods of time (i.e., over one year) based on the selection of the InGaN LEDs 155 and based on power regulation by the power regulating circuit 170. For example, by regulating the current provided to the LEDs 155 to a current that is roughly one thousand times lower than the manufacturer specification, the LEDs 155 can continuously emit light for an extended amount of time.

FIG. 6 is a diagram showing two views—a perspective view (upper portion of FIG. 6) and a side view (lower portion of FIG. 6) of components of a timepiece. In this embodiment, PCB 650 draws power from its own second battery module 610. FIG. 6 illustrates how the LED array of PCB 650, watch movement 660, and battery module 610 fit together to provide an independent circuit that wraps around the movement in this example embodiment. The LED array on PCB 650 may include two pins 620 that reach around the watch movement 660 to the battery module 610 that powers it, which is located on the other side of the movement. In this way the LED array PCB 650 and the battery module 610 sandwich around the watch movement 660.

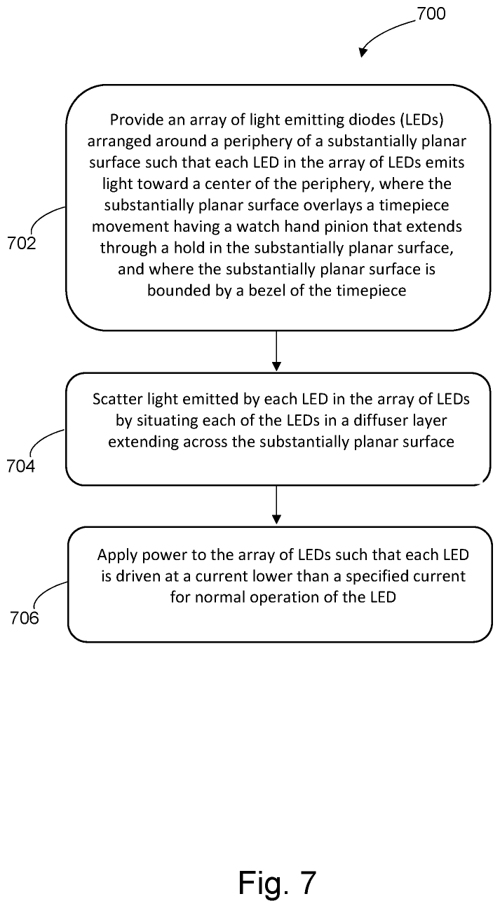

FIG. 7 is flowchart of a method 700 of illuminating a timepiece. The method 700 can be performed by one or more of the components of the timepiece 100 of FIG. 1.

The method 700 includes providing an array of LEDs arranged around a periphery of a substantially planar surface such that each LED in the array of LEDs emits light toward a center of the periphery, at 702. The substantially planar surface overlays a timepiece movement having a watch hand pinion that extends through a hole in the substantially planar surface, and the substantially planar surface is bounded by a casing of the timepiece. For example, referring to FIG. 1, the LEDs 155 can be arranged around the periphery of a substantial planar surface (e.g., the PCB 150) such that each LED 155A-C in the array of LEDs 155 emits light toward the center of the periphery. The substantially planar surface (e.g., the PCB 150) overlays a timepiece movement (e.g., the watch movement apparatus 160) having a watch hand pinion that extends through a hole in the substantially planar surface.

According to one embodiment of the method 700, the array of LEDs 155 comprises twelve (12) side-firing InGaN (Indium Gallium Nitride) LEDs each having a forward voltage of between 2.5V and 3.5V. According to one embodiment, the array of LEDs 155 is selected and arranged such that application of no more than 100 microwatts in total to the array results in each LED 155A-C emitting light.

The method 700 also includes scattering light emitted by each LED in the array of LEDs by situating each of the LEDs in a diffuser layer extending across the substantially planar surface, at 704. For example, referring to FIG. 1, the timepiece 100 can scatter light emitted by each LED 155A-C in the array of the LEDs 155 by situating each of the LEDs 155A-C in a diffuser layer (e.g., the diffuser 140) extending across the substantially planar surface (e.g., the PCB 150).

The method 700 also includes applying power to the array of LEDs such that each LED is driven at a current lower than a specified current for normal operation of the LED, at 706. For example, referring to FIG. 1, the power source 180 can apply power to the array of LEDs 155 such that each LED 155A-C is driving at a current lower than a specified current for normal operation of the LED 155A-C. Thus, applying power to the array of LEDs 155 can include connecting the array of LEDs 155 to a 3V battery (e.g., the power source 180) such that each LED 155A-C is in parallel with each other LED. According to one implementation, each LED 155A-C emits light at a current of less than one (1) microampere.

According to one embodiment, the method 700 can include providing a transparent dial over the diffuser. For example, referring to FIG. 1, the watch dial 130 can be provided over the diffuser 140.

The method 700 enables the timepiece 100 to continuously illuminate for extended periods of time (i.e., over one year) based on the selection of the InGaN LEDs 155 and based on power regulation by the power regulating circuit 170. For example, by regulating the current provided to the LEDs 155 to a current that is roughly one thousand times lower than the manufacturer specification, the LEDs 155 can continuously emit light for an extended amount of time.

### III. CONCLUSION

The particular arrangements shown in the Figures should not be viewed as limiting. It should be understood that other embodiments can include more or less of each element shown in a given Figure. Further, some of the illustrated elements can be combined or omitted. Yet further, example embodiments can include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A timepiece comprising:
an array of light emitting diodes (LEDs) disposed on a substantially planar surface;
a diffuser overlying the array of LEDs, wherein the diffuser spans substantially an entirety of the substantially planar surface to assist in scattering the light emitted by each of the LEDs such that the scattered light illuminates substantially an entirety of the diffuser; and
a dial overlying the diffuser, wherein the dial is substantially transparent to allow for the scattered light in the diffuser to be visible through the dial.

2. The timepiece of claim 1, wherein the substantially planar surface is a circuit board, and wherein the array of LEDs comprises LEDs disposed around a perimeter of the circuit board and arranged to emit light toward a center of the circuit board.

3. The timepiece of claim 1, wherein each LED in the array of LEDs is at least partially encapsulated in the diffuser.

4. The timepiece of claim 1, wherein each LED of the array of LEDs is a side-firing LED that directs light across the watch dial.

5. The timepiece of claim 1, wherein the diffuser comprises a hot melt adhesive.

6. The timepiece of claim 1, wherein the diffuser comprises a polyamide.

7. The timepiece of claim 1, wherein the substantially planar surface comprises a reflective material that reflects light from the array of LEDs.

8. A timepiece comprising:
a printed circuit board;
a plurality of light emitting diodes (LEDs) mounted to the printed circuit board;
a power regulating circuit configured to limit an average power supplied, from a power source, to the plurality of LEDs to three-hundred microwatts or less to enable substantially continuous illumination of the plurality of LEDs;
a diffuser positioned adjacent to the printed circuit board to scatter light from the plurality of LEDS to illuminate a watch dial bonded to the diffuser.

9. The timepiece of claim 8, wherein the power source is a lithium ion battery.

10. The timepiece of claim 8, wherein the plurality of LEDs comprises a plurality of parallel-connected LEDs.

11. The timepiece of claim 8, wherein the power regulating circuit limits average power supplied to the plurality of LEDs to 300 microwatts or less.

12. The timepiece of claim 8, wherein the array of LEDs comprises a plurality of LEDs selected and arranged such that application of no more than 100 microwatts in total to the array results in each LED emitting light.

13. The timepiece of claim 8, wherein the plurality of LEDs is selected and arranged such that application of no more than 20 microwatts in total results in each LED of the plurality of LEDs emitting light.

14. The timepiece of claim 8, wherein each LED of the plurality of LEDs is an Indium Gallium Nitride (InGaN) LED.

15. The timepiece of claim 8, wherein the plurality of LEDs comprises at least twelve LEDs wired in parallel, and wherein each LED of the plurality of LEDs is configured to generate light in response to receiving approximately 6 microamps from a three-volt battery for an average per-LED current of 0.5 microamps.

16. The timepiece of claim 8, further comprising:
a photodetector configured to detect when ambient light satisfies a threshold; and
a microcontroller integrated into the power regulating circuit, the microcontroller configured to disconnect the plurality of LEDs from the power source in response to a detection that the ambient light satisfies the threshold.

17. The timepiece of claim 8, further comprising:
a low power accelerometer configured to detect whether the timepiece is stationary; and
a microcontroller integrated into the power regulating circuit, the microcontroller configured to disconnect the plurality of LEDs from the power source in response to a detection that the timepiece is stationary.

18. The timepiece of claim 8, wherein the power regulating circuit comprises a set of resistors coupled in series between the power source and the plurality of LEDs.

19. The timepiece of claim 8, wherein the power regulating circuit comprises:
a microcontroller;
one or more oscillators; and
one or more inductors, wherein the power regulating circuit is configured to perform pulse width modulation to power the plurality of LEDs, and wherein the power regulating circuit is configured to limit an average power supplied, from the power source, to the plurality of LEDs to three-hundred microwatts or less to enable continuous illumination of the plurality of LEDs for at least one year.

20. A method of manufacturing a timepiece, the method comprising:
mounting a plurality of LEDs to a printed circuit board;
encapsulating the plurality of LEDs into a diffuser;
bonding the watch dial on to the diffuser such that the diffuser substantially uniformly scatters light from the plurality of LEDs to illuminate a watch dial;
coupling a power supply to the plurality of LEDs and the power regulating circuit such that the power regulating circuit limits an average power supplied from a power source to the plurality of LEDs to three-hundred microwatts or less to enable substantially continuous illumination of the plurality of LEDs.

21. The method of claim 20, wherein the power source, the power regulating circuit, the plurality of LEDs, the printed circuit board, the diffuser, and the watch dial are included in the timepiece.

22. The method of claim 20, wherein the power source is a lithium ion battery.

23. The method of claim 20, wherein the plurality of LEDs is selected and arranged such that application of no more than 100 microwatts in total to the array results in each LED emitting light.

24. The method of claim 20, wherein each LED of the plurality of LEDs is an Indium Gallium Nitride (InGaN) LED.

25. The method of claim 20, wherein the diffuser comprises a hot melt adhesive.

26. A method for providing illumination to a timepiece, comprising:
providing an array of light emitting diodes (LEDs) arranged around a periphery of a substantially planar surface such that each LED in the array of LEDs emits light toward a center of the periphery, wherein the substantially planar surface overlays a timepiece movement having a watch hand pinion that extends through a hole in the substantially planar surface, and wherein the substantially planar surface is bounded by a casing of the timepiece;
situating each of the LEDs in a diffuser layer extending across the substantially planar surface to scatter light emitted by each LED; and
applying power to the array of LEDs such that each LED is driven at a current lower than a specified current for normal operation of the LED.

27. The method of claim 26, wherein applying power to the array of LEDs comprises connecting the array of LEDs to a 3V battery such that each of the LEDs is in parallel with each other LED, and wherein each LED emits light at a current of less than 1 microampere.

28. The method of claim 26, wherein the array of LEDs comprises 12 side-firing InGaN (indium gallium nitride) LEDs each having a forward voltage of between 2.5V and 3.5V, and wherein the array of LEDs is selected and arranged such that application of no more than 100 microwatts in total to the array results in each LED emitting light.
